(19) United States
(12) Patent Application Publication
(10) Pub. No.: US 2026/0330183 A1
(43) Pub. Date: Oct. 22, 2026

(54) METHOD AND DEVICE WITH GNN-BASED INFERENCE

(71) Applicants: Samsung Electronics Co., Ltd., Suwon-si (KR); Korea Advanced Institute of Science and Technology, Daejeon (KR)

(72) Inventors: Taehwan KIM, Daejeon (KR); Lee-Sup KIM, Daejeon (KR); Yunki HAN, Daejeon (KR)

(73) Assignees: Samsung Electronics Co., Ltd., Suwon-si (KR); Korea Advanced Institute of Science and Technology, Daejeon (KR)

(21) Appl. No.: 19/468,143

(22) Filed: Feb. 3, 2026

(30) Foreign Application Priority Data
Feb. 6, 2025 (KR) 10-2025-0015021

(51) Int. Cl. G06N 3/042

(52) U.S. Cl. CPC G06N 3/042

(57) ABSTRACT

A processor-implemented method including generating, based on a first matrix multiplication between an adjacency matrix of train nodes for training a graph neural network (GNN) and a first feature matrix of the train nodes corresponding to a previous layer of the GNN, a second feature matrix corresponding to a current layer of the GNN, generating, by the second feature matrix, a first hidden feature vector of each of the train nodes and a second hidden feature vector of each of the train nodes, and generating a compressed representation of the second feature matrix based on the first hidden feature vector and the second hidden feature vector.

### CROSS-REFERENCE TO RELATED APPLICATIONS

This application claims the benefit under 35 USC § 119 (a) of Korean Patent Application No. 10-2025-0015021, filed on Feb. 6, 2025, in the Korean Intellectual Property Office, the entire disclosure of which is incorporated herein by reference for all purposes.

### BACKGROUND

### 1. Field

The following description relates to a method and device with graph neural network (GNN)-based inference.

### 2. Description of Related Art

A graph neural network (GNN) is a deep learning model for processing and/or analyzing graph data. The graph data may be organized based on edges and nodes.

A GNN may aggregate information of neighboring nodes of each node and update information (or a representation) of each node based on the aggregated information.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided an electronic device including one or more processors including processing circuitry and a memory including one or more storage media storing instructions that, when executed individually or collectively by the one or more processors, cause the electronic device to generate, based on a first matrix multiplication between an adjacency matrix of train nodes for training a graph neural network (GNN) and a first feature matrix of the train nodes corresponding to a previous layer of the GNN, a second feature matrix corresponding to a current layer of the GNN, generate, by the second feature matrix, a first hidden feature vector of each of the train nodes and a second hidden feature vector of each of the train nodes, and generate a compressed representation of the second feature matrix based on the first hidden feature vector and the second hidden feature vector.

The execution of the instructions may cause the electronic device to store the compressed representation.

The execution of the instructions may cause the electronic device to perform, based on the compressed representation, an inference on an input node by using the GNN.

The electronic device may include a processing near memory (PNM) module and the execution of the instructions may cause the electronic device to offload an operation using the compressed representation onto the PNM module, based on obtaining the input node, to perform the inference.

The execution of the instructions may cause the electronic device to generate the second feature matrix based on a second matrix multiplication between a first result matrix of the first matrix multiplication and a weight matrix of the current layer of the GNN.

The execution of the instructions may cause the electronic device to generate the second feature matrix based on applying an activation function to a second result matrix of the second matrix multiplication.

The execution of the instructions may cause the electronic device to generate the compressed representation based on concatenating the second hidden feature vector with the first hidden feature vector.

The execution of the instructions may cause the electronic device to respectively generate first concatenated feature vectors of the train nodes based on concatenating the second hidden feature vector with the first hidden feature vector, respectively generate second concatenated feature vectors of the train nodes based on compressing the first concatenated feature vectors via zero value compression (ZVC), and generate the compressed representation based on the second concatenated feature vectors.

The execution of the instructions may cause the electronic device to apply zero padding to at least one second concatenated feature vector among the second concatenated feature vectors, based on a first concatenated feature vector having a greatest number of non-zero values among the first concatenated feature vectors, to generate the compressed representation.

The execution of the instructions may cause the electronic device to compress the first concatenated feature vector having the greatest number of non-zero values to generate a second concatenated feature vector and exclude, from the second concatenated feature vectors, the second concatenated feature vector to generate remaining second concatenated feature vectors, the at least one second concatenated feature vector including the remaining second concatenated feature vectors.

A number of 0s that are zero-padded to each of the at least one second concatenated feature vector may be determined based on a difference between a first number of non-zero values included in the first concatenated feature vector having the greatest number of non-zero values and a second number of non-zero values included in each of the at least one second concatenated feature vector.

In a general aspect, here is provided a processor-implemented method including generating, based on a first matrix multiplication between an adjacency matrix of train nodes for training a graph neural network (GNN) and a first feature matrix of the train nodes corresponding to a previous layer of the GNN, a second feature matrix corresponding to a current layer of the GNN, generating, by the second feature matrix, a first hidden feature vector of each of the train nodes and a second hidden feature vector of each of the train nodes, and generating a compressed representation of the second feature matrix based on the first hidden feature vector and the second hidden feature vector.

The method may include storing the compressed representation.

The method may include performing, based on the compressed representation, an inference on an input node by using the GNN.

The performing of the inference may include offloading an operation using the compressed representation onto a processing near memory (PNM) module, based on obtaining the input node.

The generating of the second feature matrix may include generating the second feature matrix based on a second matrix multiplication between a first result matrix of the first matrix multiplication and a weight matrix of the current layer of the GNN.

The generating of the second feature matrix based on the second matrix multiplication between a first result matrix of the first matrix multiplication and a weight matrix of the current layer of the GNN may include generating the second feature matrix based on applying an activation function to a second result matrix of the second matrix multiplication.

The generating of the compressed representation may include generating the compressed representation based on concatenating the second hidden feature vector with the first hidden feature vector.

The generating of the compressed representation based on concatenating the second hidden feature vector with the first hidden feature vector may include respectively generating first concatenated feature vectors of the train nodes based on concatenating the second hidden feature vector with the first hidden feature vector, respectively generating second concatenated feature vectors of the train nodes based on compressing the first concatenated feature vectors via zero value compression (ZVC), and generating the compressed representation based on the second concatenated feature vectors.

The generating of the compressed representation based on the second concatenated feature vectors may include applying zero padding to at least one second concatenated feature vector among the second concatenated feature vectors, based on a first concatenated feature vector having the greatest number of non-zero values among the first concatenated feature vectors, to generate the compressed representation.

Other features and aspects will be apparent from the following detailed description, the drawings, and the claims.

### BRIEF DESCRIPTION OF THE DRAWINGS

FIG. 1 illustrates an example an electronic device with a an input and output according to one or more embodiments.

FIG. 2 illustrates an example graph neural network (GNN) according to one or more embodiments.

FIG. 3 illustrates an example method with generating a compressed representation of a feature matrix according to one or more embodiments.

FIG. 4 illustrates an example process of obtaining a feature matrix of train nodes according to one or more embodiments.

FIG. 5 illustrates an example process of obtaining a feature matrix of train nodes according to one or more embodiments.

FIGS. 6 and 7 illustrate example processes with compression according to one or more embodiments.

FIGS. 8 to 10 illustrate an example process according to one or more embodiments.

FIG. 11 illustrates an example method with generating an inference result from a compressed representation of a feature matrix of train nodes according to one or more embodiments.

FIGS. 12 and 13 illustrate example PNM modules according to one or more embodiments.

FIG. 14 illustrates an example method according to one or more embodiments.

FIG. 15 illustrates an example electronic apparatus according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as ‘in an or one embodiment” and ‘in an or one example embodiment’), and “one or more examples” has a same meaning as “one or more embodiments” and “one or more example embodiments”. Still further, each of multiple or all separately described an/one “example”, “embodiment”, “example embodiment”, as well as “examples”, “embodiments”, “example embodiments”, herein may be included, in combination, in a same embodiment in any combination.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

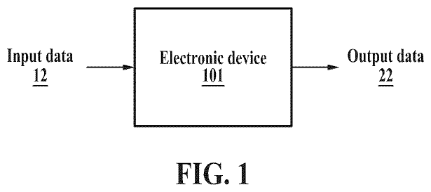

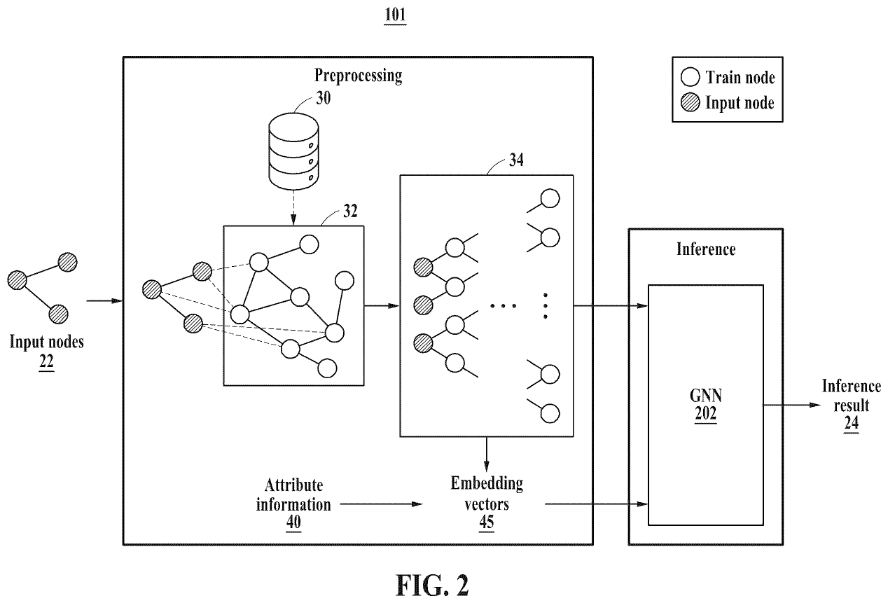

FIG. 1 illustrates an example an electronic device with a an input and output according to one or more embodiments and FIG. 2 illustrates an example graph neural network (GNN) according to one or more embodiments.

Referring to FIG. 1, in a non-limiting example, an electronic device 101 may generate output data 22 corresponding to input data 12. The electronic device 101 may use a neural network to generate the output data 22. For example, referring to FIG. 2, in a non-limiting example, the electronic device 101 may generate (or output) an inference result 24 from the input nodes 22 (e.g., test nodes) using a GNN 202.

The electronic device 101 may be a computing device capable of performing an inference using a GNN. For example, the electronic device 101 may be a server, a laptop, a computing device in a vehicle, or a mobile device (e.g., a smartphone, a tablet, a smartwatch, a virtual reality (VR) device, or an augmented reality (AR) device).

That is, in an example, electronic device 101 may perform preprocessing 30 on the input nodes 22 to generate the inference result 24. The process of performing an inference on the input nodes 22 may be referred to as an inductive step. The input nodes 22 may be batched nodes.

The electronic device 101 may generate a computational graph 34 from the input nodes 22 and train nodes 32. The train nodes 32 may be nodes used for training the GNN 202. The electronic device 101 may use attribute information (e.g., raw attribute information) of the input nodes 22 and/or attribute information 40 of edges to generate the computational graph 34. The computational graph 34 may provide connection information and operation information necessary to compute an embedding of a node or a graph (e.g., an embedding vector).

The electronic device 101 may obtain embedding vectors 45 of the input nodes 22 and the train nodes 32 based on the attribute information 40 and the computational graph 34.

In an example, the electronic device 101 may perform an inference by using the GNN 202, based on the computational graph 34 and the embedding vectors 45. The GNN 202 may be a pre-trained deep learning model, which has been pre-trained based on the train nodes 32. The electronic device 101 may generate (or output) the inference result 24 for the input nodes 22 through the inference. The inference result 24 may include feature information (e.g., a hidden feature vector) of the input nodes 22.

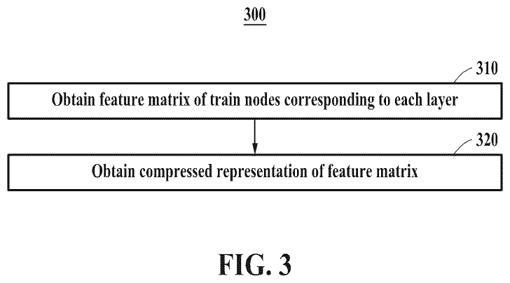

FIG. 3 illustrates an example method with generating a compressed representation of a feature matrix according to one or more embodiments.

Referring to FIG. 3, in a non-limiting example, method 300 may include operations 310 and 320. For example, a low-latency inference, such as an electronic device (e.g., the electronic device 101 of FIG. 1 and/or electronic apparatus 1500 of FIG. 15) may pre-compute a feature matrix of train nodes (e.g., the train nodes 32 of FIG. 2) before input nodes (e.g., the input nodes 22 of FIG. 2) are input.

In an example, in operation 310, the electronic device may obtain a feature matrix of train nodes corresponding to each layer of a GNN (e.g., the GNN 202 of FIG. 2). For example, when the GNN includes five layers, the electronic device may sequentially compute the feature matrix of the train nodes for each of the five layers. In an example, the feature matrix of train nodes corresponding to each layer of the GNN may represent a feature matrix of train nodes output from each layer of the GNN.

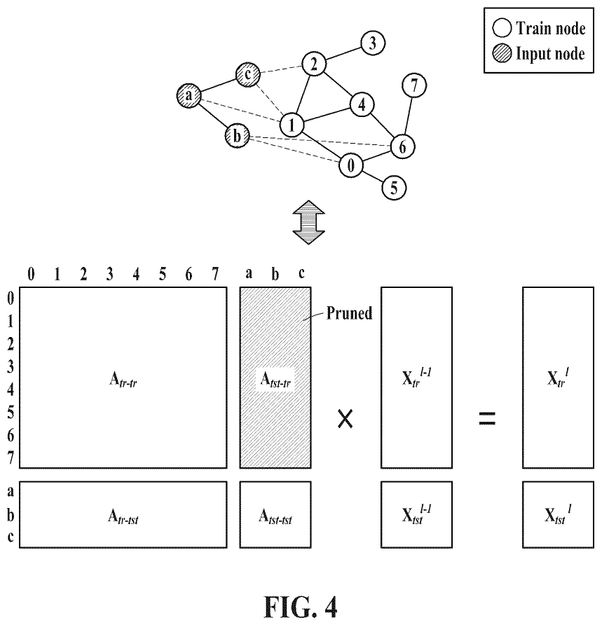

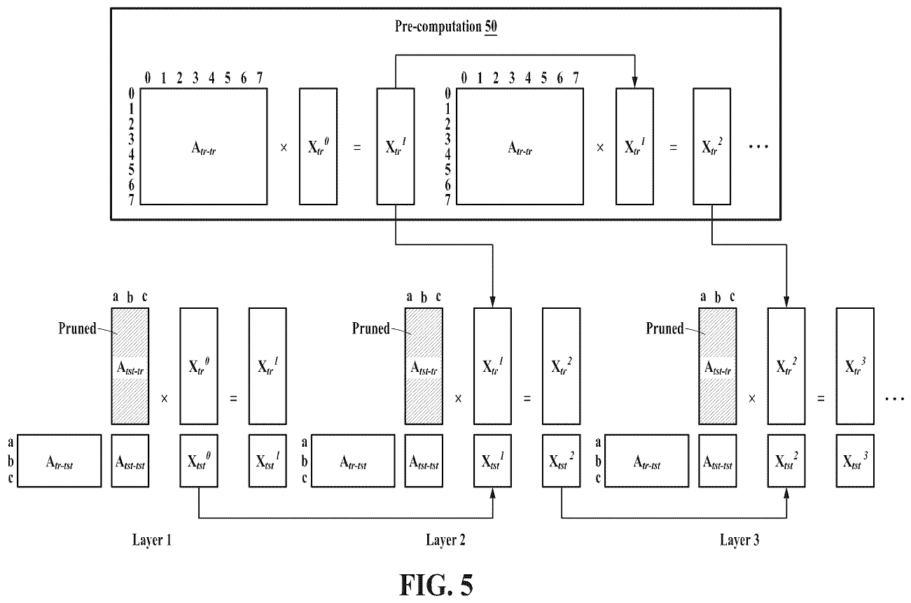

The reason why the electronic device may compute the feature matrix of the train nodes before the input nodes are provided to the electronic device is described in greater detail with reference to FIGS. 4 and 5.

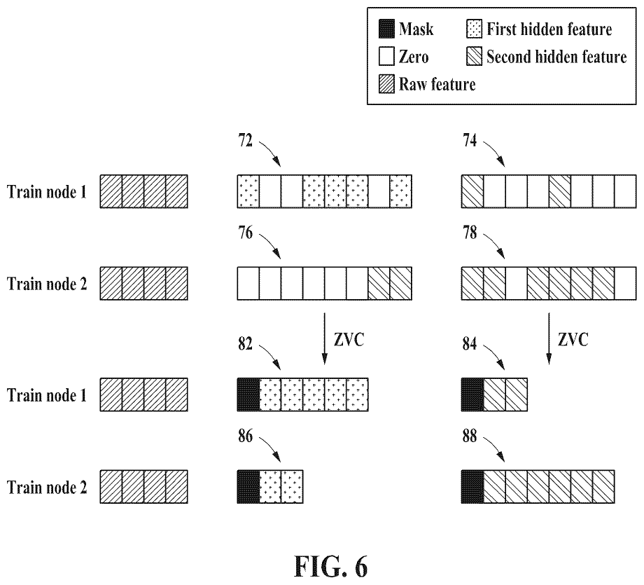

In an example, in operation 320, the electronic device may obtain a compressed representation of the feature matrix of the train nodes obtained in operation 310. The electronic device may compress the feature matrix based on zero value compression (ZVC) to obtain the compressed representation. The electronic device may store the compressed representation in a memory (e.g., a dynamic random access memory (DRAM)) of the electronic device. A method of compressing the feature matrix is described in greater detail with reference to FIGS. 6 to 10.

FIG. 4 illustrates an example process of obtaining a feature matrix of train nodes according to one or more embodiments.

Referring to FIG. 4, in a non-limiting example, an inference on input nodes a, b, and c (e.g., the input nodes 22 of FIG. 2) performed by a GNN (e.g., the GNN 202 of FIG. 2) may be expressed as in Equation 1 below.

$$\begin{matrix}[ \begin{matrix}{X}_{tr}^{l} \\ {X}_{tst}^{l}\end{matrix} ] = σ ( [ \begin{matrix}{A}_{tr - tr} & {A}_{tst - tr} \\ {A}_{tr - tst} & {A}_{tst - tst}\end{matrix} ] [ \begin{matrix}{X}_{tr}^{l - 1} \\ {X}_{tst}^{l - 1}\end{matrix} ] {W}^{l} ) , & l = 1 , 2 , … , L\end{matrix} \qquad Equation 1$$

In Equation 1, X denotes a feature matrix of a node, A denotes an adjacency matrix, W denotes a weight matrix, l denotes a layer of the GNN, tr denotes train nodes, tst denotes the input nodes (e.g., test nodes), and σ denotes an activation function (e.g., rectified linear unit (ReLU)).

Referring to Equation 1, in an example, an adjacency matrix Aₜₛₜ₋ₜᵣ between an input node and a train node may be necessary for a computation of a feature matrix

$${X}_{tr}^{l}$$

of the train node but may not be necessary for a computation of a feature matrix

$${X}_{tst}^{l}$$

of the input nodes.

In an example, the feature matrix

$${X}_{tr}^{l}$$

of train nodes 0 to 7 (e.g., the train nodes 32 of FIG. 2) may be computed as in Equation 2 below.

$${X}_{tr}^{l} = σ ( \begin{matrix}[ {A}_{tr - tr} & {A}_{tst - tr} ] ⌈ \begin{matrix}{X}_{tr}^{l - 1} \\ {X}_{tst}^{l - 1}\end{matrix} ⌉\end{matrix} {W}^{l} ) \qquad Equation 2$$

Referring to Equation 2, an adjacency matrix Aₜᵣ₋ₜᵣ between a train node and a train node and the adjacency matrix Aₜₛₜ₋ₜᵣ between an input node and a train node may be necessary to compute the feature matrix

$${X}_{tr}^{l}$$

of the train nodes 0 to 7. The adjacency matrix Aₜᵣ₋ₜᵣ between a train node and a train node may be irrelevant to an input node, while the adjacency matrix Aₜₛₜ₋ₜᵣ between an input node and a train node may be related to the input node. When an operation related to the adjacency matrix Aₜₛₜ₋ₜᵣ between the input node and a train node is be omitted from a computation process of the feature matrix

$${X}_{tr}^{l}$$

of the train nodes 0 to 7, it may be possible to pre-compute the feature matrix

$${X}_{tr}^{l}$$

of the train nodes 0 to 7 before the input nodes a, b, and c are provided to the electronic device.

When the adjacency matrix Aₜₛₜ₋ₜᵣ between an input node and a train node is pruned, the inference on the input nodes may be expressed as in Equation 3 below.

$$\begin{matrix}[ \begin{matrix}{X}_{tr}^{l} \\ {X}_{tst}^{l}\end{matrix} ] = σ ( [ \begin{matrix}{A}_{tr - tr} & 0 \\ {A}_{tr - tst} & {A}_{tst - tst}\end{matrix} ] [ \begin{matrix}{X}_{tr}^{l - 1} \\ {X}_{tst}^{l - 1}\end{matrix} ] {W}^{l} ) , & l = 1 , 2 , … , L\end{matrix} \qquad Equation 3$$

Referring to Equation 3, the feature matrix

$${X}_{tr}^{l}$$

of the train nodes 0 to 7 corresponding to each layer of the GNN may be computed as in Equation 4, and the feature matrix

$${X}_{tst}^{l}$$

of the input nodes corresponding to each layer of the GNN may be computed as in Equation 5.

$${X}_{tr}^{l} = σ ( {A}_{tr - tr} {X}_{tr}^{l - 1} {W}^{l} ) \qquad Equation 4$$

$${X}_{tst}^{l} = σ ( [ \begin{matrix}{A}_{tr - tst} & {A}_{tst - tst}\end{matrix} ] [ \begin{matrix}{X}_{tr}^{l - 1} \\ {X}_{tst}^{l - 1}\end{matrix} ] {W}^{l} ) \qquad Equation 5$$

Referring to FIG. 5, the electronic device may perform a process 50 of computing the feature matrix

$${X}_{tr}^{l}$$

of train nodes (e.g., the train nodes 0 to 7 of FIG. 4) corresponding to each layer of a GNN in advance before the input nodes a, b, and c are provided. A component of the electronic device that performs the process 50 may be a processor (e.g., a central processing unit (CPU) such as processor 1520).

When the feature matrix

$${X}_{tr}^{l}$$

of the train nodes is pre-computed before the input nodes a, b, and c are provided, a neighboring explosion issue in an inference operation may be alleviated. For example, when the feature matrix

$${X}_{tr}^{l}$$

of the train nodes is obtained in advance before the input nodes a, b, and c are provided, a complexity of the inference operation may be reduced from O(d^{l}) to O(ld).

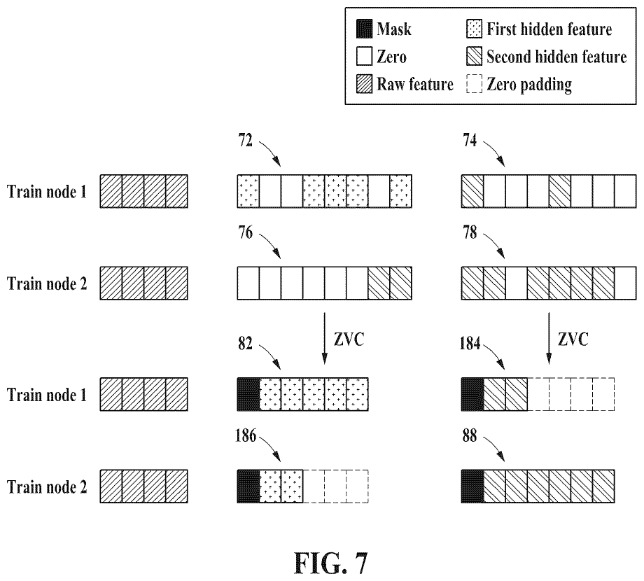

FIGS. 6 and 7 illustrate example processes with compression according to one or more embodiments.

Referring to FIG. 6, in a non-limiting example, an electronic device (e.g., the electronic device 101 of FIG. 1 and/or electronic apparatus 1500) may compress the feature matrix

$${X}_{tr}^{l}$$

of train nodes (e.g., the train nodes 0 to 7 of FIG. 4) corresponding to each layer of a GNN (e.g., the GNN 202 of FIG. 2). Although FIGS. 6 and 7 only illustrate a first hidden feature vector and a second hidden feature vector of each of two train nodes (e.g., a train node 1 and a train node 2), this is only an example for ease of description. For example, the number of hidden feature vectors for each of the train nodes may be greater, for example they may correspond to the number of layers of the GNN.

In an example, the electronic device may obtain (or extract) hidden feature vectors of each of the train nodes from the feature matrix

$${X}_{tr}^{l}$$

of the train nodes. For example, the electronic device may obtain a first hidden feature vector 72 and a second hidden feature vector 74 of the train node 1 from the feature matrix

$${X}_{tr}^{l} .$$

For example, the electronic device may obtain a first hidden feature vector 76 and a second hidden feature vector 78 of the train node 2 from the feature matrix

$${X}_{tr}^{l} .$$

The electronic device may compress the hidden feature vectors of each of the train nodes based on ZVC. For example, the electronic device may convert the first hidden feature vector 72 and the first hidden feature vector 76 of the train node 1 into a first compressed hidden feature vector 82 and a first compressed hidden feature vector 86, respectively. For example, the electronic device may convert the second hidden feature vector 74 and the second hidden feature vector 78 of the train node 2 into a second compressed hidden feature vector 84 and the second compressed hidden feature vector 88, respectively.

As illustrated in FIG. 6, when the hidden feature vectors include different numbers of non-zero values, the lengths of the compressed hidden feature vectors may be different. For example, when the first hidden feature vector 72 of the train node 1 includes five non-zero values and the first hidden feature vector 76 of the train node 2 includes two non-zero values, a length of the first compressed hidden feature vector 82 of the train node 1 and a length of the first compressed hidden feature vector 86 of the train node 2 may result in being different sizes from each other.

In order to directly access vectors stored in a memory using a node index, lengths of the vectors may need to be identical. Hereinafter, for ease of description, it is assumed that among first hidden feature vectors of the train nodes, the first hidden feature vector 72 of the train node 1 includes the greatest number of non-zero values, and among second hidden feature vectors of the train nodes, the second hidden feature vector 78 of the train node 2 includes the greatest number of non-zero values.

Referring to FIG. 7, in a non-limiting example, an electronic device (e.g., the electronic device 101 of FIG. 1 and/or electronic apparatus 1500) may apply zero padding to the compressed hidden feature vectors so that the lengths of the compressed hidden feature vectors may be equal to each other. For example, the electronic device may apply zero padding, among corresponding hidden feature vectors (e.g., the first hidden feature vectors or the second hidden feature vectors), to the corresponding feature vectors, based on a hidden feature vector having the greatest number of non-zero values. For example, when the first hidden feature vector 72 of the train node 1 among the first hidden feature vectors includes the greatest number of non-zero values, the electronic device may apply zero padding to first compressed hidden feature vectors of each of the other train nodes except for the first compressed hidden feature vector 82 of the train node 1 among the first compressed hidden feature vectors. For example, the electronic device may apply zero padding to the first compressed hidden feature vector 186 of the train node 2.

The number of ‘0’s to be zero-padded to a compressed hidden feature vector may be determined based on a difference between a number of non-zero values included in a hidden feature vector having a greatest number of non-zero values and a number of non-zero values included in a hidden feature vector corresponding to the compressed hidden feature vector. For example, the number of ‘0’s zero-padded to the first compressed hidden feature vector 86 of the train node 2 may be a difference (e.g., “2”) between the number (e.g., “5”) of non-zero values included in the first hidden feature vector 72 of the train node 1 and the number (e.g., “3”) of non-zero values included in the first hidden feature vector 76 of the train node 2. Similarly, the second compressed hidden feature vector 184 of the train node 1 may be zero-padded with four ‘0’s.

As described above, when individually compressing the hidden feature vectors (e.g., the first hidden feature vector and the second hidden feature vector) of each of the train nodes, a large number of ‘0’s may need to be zero-padded. Accordingly, a compression efficiency of the vectors may be reduced.

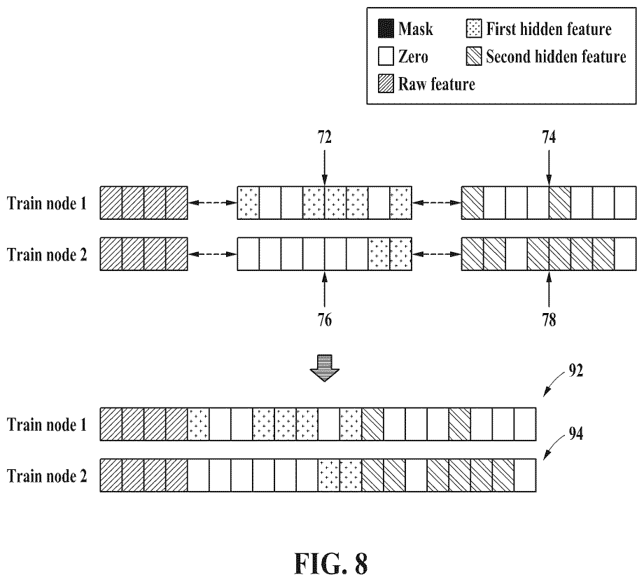

FIGS. 8 to 10 illustrate an example process according to one or more embodiments.

Referring to FIG. 8, in a non-limiting example, a process of generating a first concatenated feature vector of each of train nodes is illustrated.

In FIG. 8, an electronic device (e.g., the electronic device 101 of FIG. 1 and/or the electronic apparatus 1500) may generate the first concatenated feature vector by concatenating hidden feature vectors of each of train nodes (e.g., the train nodes 0 to 7 of FIG. 4) to increase a compression efficiency. Although FIG. 8 illustrates that not only the hidden feature vectors but also the raw feature vectors are concatenated to each other to generate the first concatenated feature vector, examples of the present disclosure are not limited thereto. For example, the electronic device may concatenate hidden feature vectors excluding the raw feature vectors to generate the first concatenated feature vector.

For example, the electronic device may generate a first concatenated feature vector 92 of a train node 1 by concatenating a raw feature vector, the first hidden feature vector 72, and the second hidden feature vector 74 of the train node 1.

For example, the electronic device may generate a first concatenated feature vector 94 of a train node 2 by concatenating a raw feature vector, the first hidden feature vector 76, and the second hidden feature vector 78 of the train node 2.

Although FIG. 8 illustrates that the raw feature vector of the train node 1 and the raw feature vector of the train node 2 have the same number of non-zero values, this is only an example for ease of description, and the scope of the present disclosure is not limited thereto. For example, the number of non-zero values included in the raw feature vector of the train node 1 and the number of non-zero values included in the raw feature vector of the train node 2 may be different from each other.

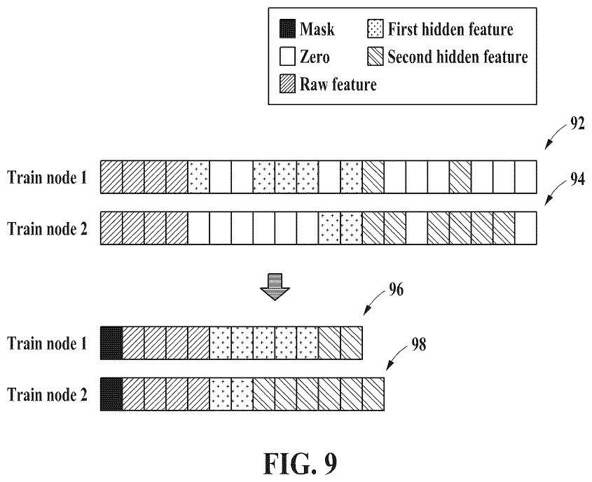

Referring to FIG. 9, in a non-limiting example, a process of generating a second concatenated feature vector of each of train nodes is illustrated.

In FIG. 9, the electronic device may compress a first concatenated feature vector of each of the train nodes via ZVC to generate the second concatenated feature vector of each of the train nodes. For example, the electronic device may generate a second concatenated feature vector 96 of the train node 1 based on compressing the first concatenated feature vector 92 of the train node 1. For example, the electronic device may generate a second concatenated feature vector 98 of a train node 2 based on compressing a first concatenated feature vector 94 of the train node 2. Hereinafter, for ease of description, it is assumed that the first concatenated feature vector 94 of the train node 2, among the first concatenated feature vectors of the train nodes, includes the greatest number of non-zero values.

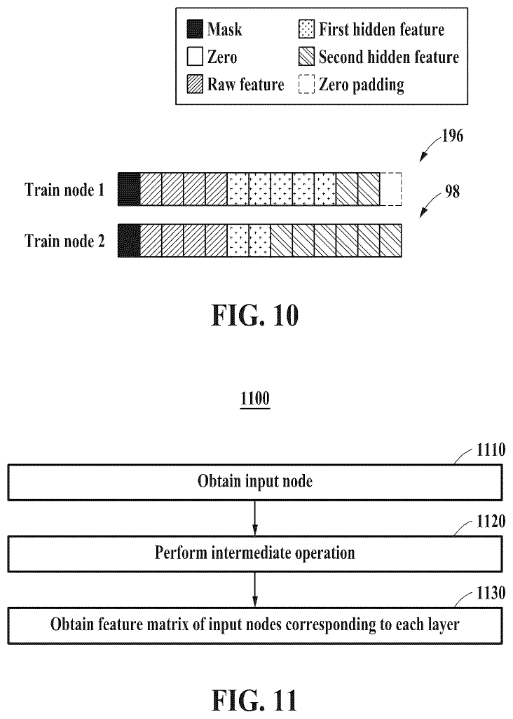

Referring to FIG. 10, in a non-limiting example, a process of applying zero padding to the second concatenated feature vector is illustrated.

In FIG. 10, the electronic device may apply zero padding to second concatenated feature vectors of train nodes.

The electronic device may determine at least one second concatenated feature vector to which zero padding is to be applied based on the first concatenated feature vector including the greatest number of non-zero values among the first concatenated feature vectors of the train nodes. For example, the electronic device may apply zero padding to remaining second concatenated feature vectors 196 obtained by excluding, from the second concatenated feature vectors, the second concatenated feature vector 98 generated by compressing the first concatenated feature vector 94 having the greatest number of non-zero values.

The number of ‘0’s to be zero-padded to the second concatenated feature vector (e.g., the second concatenated feature vector 96 of a train node 1) may be determined based on a difference between a number of non-zero values included in the first concatenated feature vector (e.g., the first concatenated feature vector 94 of a train node 2) having the greatest number of non-zero values and a number of non-zero values included in a first concatenated feature vector (e.g., the first concatenated feature vector 92 of the train node 1) corresponding to a corresponding second concatenated feature vector. For example, the number of ‘0’s zero-padded to the second concatenated feature vector 196 of the train node 1 may be a difference (e.g., “1”) between the number (e.g., “8”) of non-zero values included in the first concatenated feature vector 94 of the train node 2 and the number (e.g., “7”) of non-zero values included in the first concatenated feature vector 92 of the train node 1.

Typically, the second-level concatenated feature vectors of the train nodes may include similar numbers of non-zero values. For example, a difference between the number of non-zero values included in the second concatenated feature vector 96 of the train node 1 and the number of non-zero values included in the second concatenated feature vector 98 of the train node 2 may be very small. When zero padding is applied to the second connected feature vectors generated based on concatenating the hidden feature vectors, the number of ‘0’s that need to be zero-padded may be reduced, and the a compression efficiency may be increased.

The electronic device may generate a compressed representation (e.g., a compressed feature matrix) of a feature matrix (e.g., the feature matrix

$${X}_{tr}^{l}$$

of Equation 4) of the train nodes based on second concatenated feature vectors to which zero padding is applied and may store the compressed representation in a memory (e.g., DRAM).

The electronic device may adjust a threshold value of an activation function (e.g., the activation function σ of Equation 1) to increase the compression efficiency. For example, an electronic device may adjust the threshold value of ReLU to a value greater than ‘0.’ The threshold value may be set based on a range of accuracy degradation that is acceptable. FIG. 11 illustrates an example method with generating an inference result from a compressed representation of a feature matrix of train nodes according to one or more embodiments.

Referring to FIG. 11, in a non-limiting example, method may include operations 1110, 1120, and 1130 where an electronic device (e.g., the electronic device 101 of FIG. 1 and/or the electronic apparatus 1500 of FIG. 15) may perform an inference on an input node based on a compressed representation (e.g., the compressed representation of the feature matrix of the train nodes described with reference to FIG. 10) of a feature matrix of train nodes (e.g., the train nodes 0 to 7 of FIG. 4).

In an example, in operation 1110, the electronic device may obtain an input node (e.g., the input nodes a, b, and c of FIG. 4).

In an example, in operation 1120, the electronic device may perform an intermediate operation to obtain an inference result for the input node. The electronic device may perform the intermediate operation using a PNM module. A processor (e.g., a host) of the electronic device may offload the intermediate operation onto a PNM module.

For example, the intermediate operation may refer to an operation (e.g., an aggregation operation), among the operations of Equation 5, which is related to an adjacency matrix Aₜₛₜ₋ₜᵣ between a train node and an input node. The intermediate operation may be expressed as in Equation 6 below.

$${Z}_{tr - tst}^{1} = {A}_{tr - tst} {X}_{tr}^{0} \qquad Equation 6$$

$${Z}_{tr - tst}^{2} = {A}_{tr - tst} {X}_{tr}^{1}$$

$$⋮$$

$${Z}_{tr - tst}^{L} = {A}_{tr - tst} {X}_{tr}^{L - 1}$$

$$\to [ {Z}_{tr - tst}^{L} \vert {Z}_{tr - tst}^{L - 1} \vert … \vert {Z}_{tr - tst}^{1} ] = {A}_{tr - tst} [ {X}_{tr}^{L - 1} \vert {X}_{tr}^{L - 2} \vert … \vert {X}_{tr}^{0} ]$$

In an example, in operation 1130, the electronic device may compute a feature matrix (e.g., the feature matrix

$${X}_{tst}^{l}$$

of Equation 5) of an input node corresponding to each layer of a GNN (e.g., the GNN 202 of FIG. 2) based on a result value of the intermediate operation. The electronic device may use the processor to compute the feature matrix of the input node.

In an example, a process of computing the feature matrix of the input node may be expressed as in Equation 7 below.

$${Z}_{tst - tst}^{1} = {A}_{tst - tst} {X}_{tst}^{0} \qquad Equation 7$$

$${X}_{tst}^{1} = σ ( ( {Z}_{tst - tst}^{1} + {Z}_{tr - tst}^{1} ) {W}^{l} )$$

$$⋮$$

$${Z}_{tst - tst}^{L} = {A}_{tst - tst} {X}_{tst}^{L - 1}$$

$${X}_{tst}^{L} = σ ( ( {Z}_{tst - tst}^{L} + {Z}_{tr - tst}^{L} ) {W}^{L} )$$

The electronic device may output the inference result for the input node. The inference result may include a feature matrix

$${X}_{tst}^{L}$$

of an input node corresponding to a last layer of the GNN.

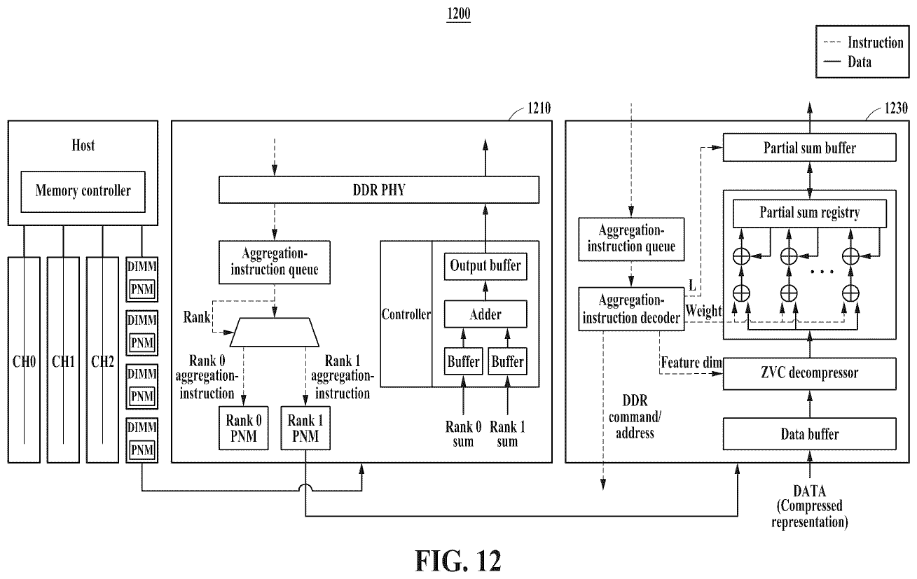

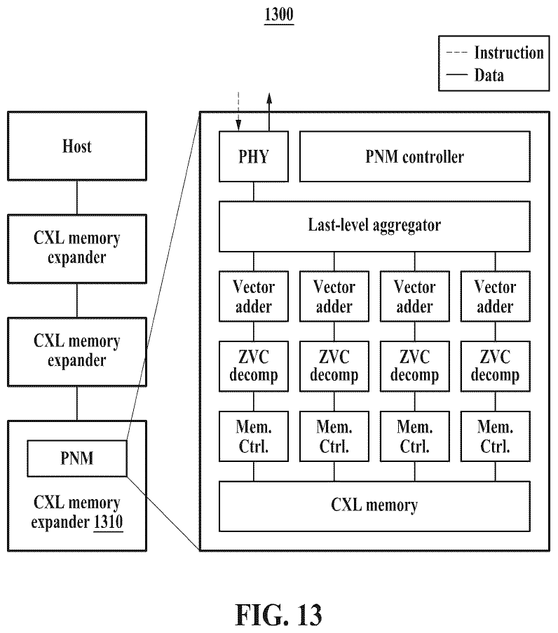

FIGS. 12 and 13 illustrate example PNM apparatuses according to one or more embodiments. Referring to FIG. 12, in a non-limiting example, a block diagram of an example of a dual inline memory module (DIMM)-based PNM apparatus 1200 is illustrated while in FIG. 13, in a non-limiting example, a compute express link (CXL)-based PNM apparatus is illustrated.

Referring to FIG. 12, an electronic device (e.g., the electronic device 101 of FIG. 1 and/or electronic apparatus 1500) may perform an intermediate operation (e.g., the intermediate operation of Equation 6) using a PNM apparatus 1200. As described above, since the intermediate operation may use a compressed representation (e.g., the compressed representation of the feature matrix of the train nodes of FIG. 10) of a feature matrix of train nodes (e.g., the train nodes 0 to 7 of FIG. 4) stored in a memory (e.g., DRAM), the operation speed may be improved when the intermediate operation is processed through a PNM apparatus. It should be noted that the number of channels, the number of DIMMs, and/or the number of ranks illustrated in FIG. 12 are examples for descriptive purposes only.

A DIMM-level PNM apparatus 1210 may transfer instructions from a host (e.g., a processor) to a rank-level PNM apparatus 1230.

The rank-level PNM apparatus 1230 may perform the intermediate operation using the compressed representation of the feature matrix of the train nodes stored in the memory (e.g., DRAM) based on the instruction transferred from the DIMM-level PNM apparatus 1210. For example, the rank-level PNM apparatus 1230 may perform the intermediate operation based on hidden dimension information of each layer provided by the instruction.

The DIMM-level PNM apparatus 1210 may include a data buffer. The data buffer may have an individual access to non-zero values and/or a mask (e.g. a bit mask) that provides information on an original location of the non-zero values.

The rank-level PNM apparatus 1230 may include a ZVC decompressor to process the compressed representation. The ZVC decompressor may decompress a compressed representation (e.g., a matrix in a ZVC format) corresponding to each layer based on information provided by a mask (e.g., a bit mask). The compressed representation may be transformed into a matrix in a dense format by the ZVC decompressor.

The rank-level PMM apparatus 1230 may perform an operation (e.g., an aggregation operation) as many times as possible within a corresponding rank and generate an operation result (e.g., a partial sum). The rank-level PNM apparatus 1230 may transfer the operation result to the DIMM-level PNM apparatus 1210 based on a control signal L.

The DIMM-level PNM apparatus 1210 may process (e.g., perform an adding operation) operation results received from each of rank-level PNM apparatuses and transfer an intermediate operation result to the host.

Referring to FIG. 13, a CXL-based PNM 1300 may may perform an intermediate operation (e.g., the intermediate operation of Equation 6) using, among other elements, a PNM apparatus of a CXL memory expander 1310.

As described above, with respect to Operation 1130 and Equation 6, the CXL memory expander 1310 may provide an improved capacity and/or inner bandwidth by including a plurality of memory channels within the CXL memory expander.

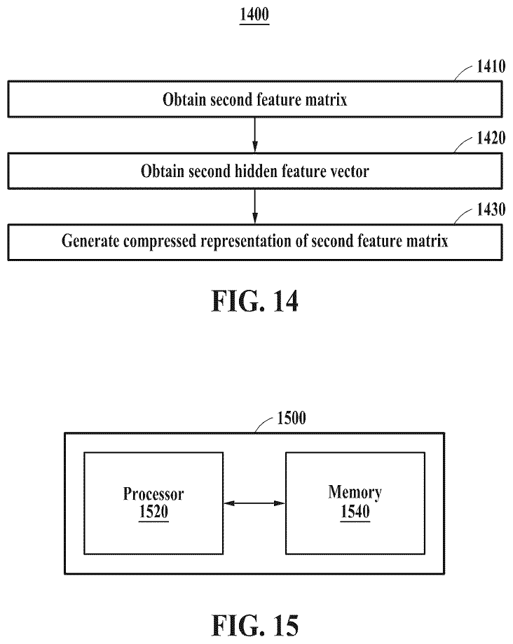

FIG. 14 illustrates an example method according to one or more embodiments.

Referring to FIG. 14, in a non-limiting example, method 1400 may include operations 1410, 1420, and 1430 where an electronic device (e.g., the electronic device 101 of FIG. 1) may perform an inference on an input node using a GNN (e.g., the GNN 202 of FIG. 2) and output an inference result. Since operations 1410 to 1430 may be substantially identical to the operations of the electronic device described above, a repeated description thereof is omitted.

In an example, in operation 1410, the electronic device may generate, or obtain, a second feature matrix based on a first matrix multiplication between an adjacency matrix (e.g., an adjacency matrix Aₜᵣ₋ₜᵣ of Equation 4) of train nodes (e.g., the train nodes 32 of FIG. 2 or the train nodes a, b, and c of FIG. 4) for training the GNN and a first feature matrix (e.g., the feature matrix

$${X}_{t r}^{l - 1}$$

of Equation 4) of the train nodes corresponding to a previous layer of the GNN, where the second feature matrix (e.g., the feature matrix

$${X}_{t r}^{l}$$

of Equation 4) corresponds to a current layer of the GNN.

In an example, in operation 1420, the electronic device may generate by, or obtain from, the second feature matrix, a first hidden feature vector (e.g., the first hidden feature vector 72 or the first hidden feature vector 76 of FIG. 8) of each of the train nodes and a second hidden feature vector (e.g., the second hidden feature vector 74 or the second hidden feature vector 78 of FIG. 8) of each of the train nodes.

In an example, in operation 1430, the electronic device may generate a compressed representation of the second feature matrix based on the first hidden feature vector and the second hidden feature vector.

FIG. 15 illustrates an example electronic apparatus according to one or more embodiments.

Referring to FIG. 15, in a non-limiting example, an electronic apparatus 1500 may include at least one processor 1520 and a memory 1540. In an example, the electronic apparatus 1500 may make up or be the electronic device 101. That is, as described below, the processors and neural networks employed in electronic device, such as GNN 202, may be embodied by the elements of electronic apparatus 1500.

The memory 1540 may include computer-readable instructions. The at least one processor 1520 may be configured to execute computer-readable instructions, such as those stored in the memory 1540, and through execution of the computer-readable instructions, the at least one processor 1520 may be configured to perform one or more, or any combination, of the operations and/or methods described herein.

The memory 1540 may include one or more computer-readable storage media. The memory 1540 may include non-volatile storage elements (e.g., a magnetic hard disk, an optical disc, a floppy disc, a flash memory device, erasable programmable read-only memory (EPROM), and electrically erasable programmable read-only memory (EEPROM).

The memory 1540 may include PNM apparatuses (e.g., the DIMM-level PNM apparatus 1210 and the rank-level PNM apparatus 1230 of FIG. 12).

The memory 1540 may be a non-transitory medium. The term “non-transitory” may indicate that the storage medium is not embodied in a carrier wave or a propagated signal. However, the term “non-transitory” should not be interpreted to mean that the memory 1540 is non-movable.

The at least one processor 1520 may process data stored in the memory 1540. The at least one processor 1520 may execute computer-readable code (e.g., software) stored in the memory 1540 and instructions triggered by the at least one processor 1520.

The at least one processor 1520 may be a data processing device implemented as hardware including a circuit having a physical structure to execute desired operations. The desired operations may include, for example, instructions or code included in a program.

The at least one processor 1520 may be configured to execute programs or applications to configure the at least one processor 1520 to control the electronic apparatus 1500 to perform one or more or all operations and/or methods involving GNN based inference and may include, for example, a microprocessor, a central processing unit (CPU), a processor core, a multi-core processor, a multiprocessor, an application-specific integrated circuit (ASIC), and a field-programmable gate array (FPGA).

For example, the at least one processor 1520 may include a main processor (e.g., a CPU or an application processor) and an auxiliary processor (e.g., a communication processor, a neural processing unit (NPU), and/or a graphics processing unit (GPU)).

The at least one processor 1520 may cause the electronic device 101 to perform at least one operation by individually or collectively executing code, instructions, and/or applications stored in the memory 1540.

The electronic devices and apparatuses, processors, memories, neural networks, electronic device 101, GNN 202, PNM apparatus 1200, DIMM-level PNM apparatus 1210, rank-level PNM apparatus 1230, CXL-based PNM 1300, CXL memory expander 1310, electronic apparatus 1500, one or more processor 1520, and memory 1540 described herein, including descriptions with respect to respect to FIGS. 1-15, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-15 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An electronic device, comprising:
one or more processors comprising processing circuitry; and
a memory comprising one or more storage media storing instructions that, when executed individually or collectively by the one or more processors, cause the electronic device to:
generate, based on a first matrix multiplication between an adjacency matrix of train nodes for training a graph neural network (GNN) and a first feature matrix of the train nodes corresponding to a previous layer of the GNN, a second feature matrix corresponding to a current layer of the GNN;
generate, by the second feature matrix, a first hidden feature vector of each of the train nodes and a second hidden feature vector of each of the train nodes; and
generate a compressed representation of the second feature matrix based on the first hidden feature vector and the second hidden feature vector.

2. The electronic device of claim 1, wherein the execution of the instructions causes the electronic device to:
store the compressed representation.

3. The electronic device of claim 1, wherein the execution of the instructions causes the electronic device to:
perform, based on the compressed representation, an inference on an input node by using the GNN.

4. The electronic device of claim 3, further comprising:
a processing near memory (PNM) module,
wherein the execution of the instructions causes the electronic device to:
offload an operation using the compressed representation onto the PNM module, based on obtaining the input node, to perform the inference.

5. The electronic device of claim 1, wherein the execution of the instructions causes the electronic device to:
generate the second feature matrix based on a second matrix multiplication between a first result matrix of the first matrix multiplication and a weight matrix of the current layer of the GNN.

6. The electronic device of claim 5, wherein the execution of the instructions causes the electronic device to:
generate the second feature matrix based on applying an activation function to a second result matrix of the second matrix multiplication.

7. The electronic device of claim 1, wherein the execution of the instructions causes the electronic device to:
generate the compressed representation based on concatenating the second hidden feature vector with the first hidden feature vector.

8. The electronic device of claim 7, wherein the execution of the instructions causes the electronic device to:
respectively generate first concatenated feature vectors of the train nodes based on concatenating the second hidden feature vector with the first hidden feature vector;
respectively generate second concatenated feature vectors of the train nodes based on compressing the first concatenated feature vectors via zero value compression (ZVC); and
generate the compressed representation based on the second concatenated feature vectors.

9. The electronic device of claim 8, wherein the execution of the instructions causes the electronic device to:
apply zero padding to at least one second concatenated feature vector among the second concatenated feature vectors, based on a first concatenated feature vector having a greatest number of non-zero values among the first concatenated feature vectors, to generate the compressed representation.

10. The electronic device of claim 9, wherein the execution of the instructions causes the electronic device to:
compress the first concatenated feature vector having the greatest number of non-zero values to generate a second concatenated feature vector; and
exclude, from the second concatenated feature vectors, the second concatenated feature vector to generate remaining second concatenated feature vectors,
wherein the at least one second concatenated feature vector comprises the remaining second concatenated feature vectors.

11. The electronic device of claim 9, wherein a number of 0s that are zero-padded to each of the at least one second concatenated feature vector is determined based on a difference between a first number of non-zero values included in the first concatenated feature vector having the greatest number of non-zero values and a second number of non-zero values included in each of the at least one second concatenated feature vector.

12. A processor-implemented method, the method comprising:
generating, based on a first matrix multiplication between an adjacency matrix of train nodes for training a graph neural network (GNN) and a first feature matrix of the train nodes corresponding to a previous layer of the GNN, a second feature matrix corresponding to a current layer of the GNN;
generating, by the second feature matrix, a first hidden feature vector of each of the train nodes and a second hidden feature vector of each of the train nodes; and
generating a compressed representation of the second feature matrix based on the first hidden feature vector and the second hidden feature vector.

13. The method of claim 12, further comprising:
storing the compressed representation.

14. The method of claim 12, further comprising:
performing, based on the compressed representation, an inference on an input node by using the GNN.

15. The method of claim 14, wherein the performing of the inference comprises:
offloading an operation using the compressed representation onto a processing near memory (PNM) module, based on obtaining the input node.

16. The method of claim 12, wherein the generating of the second feature matrix comprises:
generating the second feature matrix based on a second matrix multiplication between a first result matrix of the first matrix multiplication and a weight matrix of the current layer of the GNN.

17. The method of claim 16, wherein the generating of the second feature matrix based on the second matrix multiplication between a first result matrix of the first matrix multiplication and a weight matrix of the current layer of the GNN comprises:
generating the second feature matrix based on applying an activation function to a second result matrix of the second matrix multiplication.

18. The method of claim 12, wherein the generating of the compressed representation comprises:
generating the compressed representation based on concatenating the second hidden feature vector with the first hidden feature vector.

19. The method of claim 18, wherein the generating of the compressed representation based on concatenating the second hidden feature vector with the first hidden feature vector comprises:
respectively generating first concatenated feature vectors of the train nodes based on concatenating the second hidden feature vector with the first hidden feature vector;
respectively generating second concatenated feature vectors of the train nodes based on compressing the first concatenated feature vectors via zero value compression (ZVC); and
generating the compressed representation based on the second concatenated feature vectors.

20. The method of claim 19, wherein the generating of the compressed representation based on the second concatenated feature vectors comprises:
applying zero padding to at least one second concatenated feature vector among the second concatenated feature vectors, based on a first concatenated feature vector having the greatest number of non-zero values among the first concatenated feature vectors, to generate the compressed representation.
